(19) United States
(12) Patent Application Publication
(10) Pub. No.: US 2008/0251182 A1
(43) Pub. Date: Oct. 16, 2008

(54) IN LINE WEB TREATING AND SUBSTRATE FORMING METHOD FOR OVERLAID PRODUCTS

(75) Inventors: Vincent B. Thomas, Athens, GA (US); Christopher J. Rogers, Braselton, GA (US); Winford Terry Liles, Jefferson, GA (US)

Correspondence Address: J M HUBER CORPORATION, 333 THORNALL STREET, PATENT DEPARTMENT, EDISON, NJ, 08837-2220, US

(73) Assignee: Huber Engineered Woods LLC, Charlotte, NC (US)

(21) Appl. No.: 11/734,162

(22) Filed: Apr. 11, 2007

(51) Int. Cl. B27N 3/00

(52) U.S. Cl. 156/62.2

(57) ABSTRACT

A method for preparing an overlaid composite product comprises treating a web comprising a functional barrier on one face of the web with a binding agent; placing the treated web directly adjacent an unconsolidated substrate wherein the unconsolidated substrate comprises an uncured first resin; and concurrently consolidating the unconsolidated substrate and curing the binding agent and first resin thereby bonding the web to the substrate without addition of a separate adhesive. An overlaid composite product produced by this method is described. An overlaid composite product can be, e.g., a paper laminated oriented strand board.

### BACKGROUND

Resin-saturated kraft paper has been added to different wood substrates (oriented strand board, engineered wood products, particleboard, medium density fiber board, hardboard, paperboard, etc.) for a variety of end use applications. The paper overlays are adhered to the wood substrate by post laminating using a secondary short cycle press, or by simultaneously laminating the paper during the primary process (process prior to and including press) of making the wood product. For example, one process involves adding a saturated kraft paper overlay to oriented strand board during the primary process of forming and consolidating the strands (see, e.g., U.S. Pat. No. 6,737,155 or U.S. Publication 2005/0229504). An end product generated by this primary process is an oriented strand board (OSB) sheathing product with barrier properties for use as a water resistant barrier sheathing product (e.g., ZIP System™ Wall Sheathing or ZIP System™ Roof Sheathing; http: www.huberwood.com/).

The most commonly currently used process for creating overlaid wood substrate involves two separate and distinct steps. One is preparing the paper overlay, and the second is laminating the prepared paper overlay to the wood substrate either in a primary or secondary process. These two processes can be further broken down into the individual steps involved with each task.

Conventional preparation of the paper overlay starts with an absorbent paper specifically formulated to be impregnated with resins. That absorbent paper must then be shipped to a paper saturating facility. The paper is set on an unwind machine and systematically fed into an immersion bath of a resin solution (or other saturating process). After the resination, the resinated paper then passes through an oven to evaporate the solvents in the resin and to partially stage or fully cure the resin. Extreme care must be taken during the oven step to evaporate the correct amount of solvents in the resin so that a desired level of uncured volatiles remains. The amount of uncured volatiles remaining corresponds to the degree of staging required for the paper product. Typically, the final product from the oven step is “C staged,” meaning it is almost fully cured leaving 2 or 3% uncured volatiles. Next, a resin glue line is applied to one side of the resinated paper, and then the resinated paper with glue line is run through a second oven for staging of the glue line. The final paper overlay then travels through a cooling chamber and is rewound and shipped to a wood product mill for use on wood products.

At the mill, the final rolls of resinated paper overlay with glue line are unwound and fed onto the, e.g., OSB, forming line (where wood strands are oriented into a mat). If the paper overlay is fed onto the bottom of the mat, it must be fed onto the forming line before orienting the wood strands. In a final step, the paper overlay and mat of oriented wood strands is consolidated under heat and pressure into the final panel product with a paper laminated face.

Although the process of adding a paper overlay laminate to the OSB simultaneously during the primary process is much simplified from the process of pressing the overlay laminate on with a secondary press step, there still exist a number of steps in saturating and preparing the paper. Subsequently, there exists a need to simplify this process providing for more manufacturing flexibility, reducing energy usage, and providing material cost savings. Other example problems with previous processes include lack of cohesiveness of the overlay to the substrate, release problems of the resinated paper from the processing equipment, and contamination of the equipment and/or product.

### SUMMARY OF THE INVENTION

In one aspect, described herein is a method for preparing overlaid composite products comprising treating a web comprising a functional barrier on one face of the web with a binding agent; placing the treated web directly adjacent an unconsolidated substrate wherein the unconsolidated substrate comprises an uncured first resin; and concurrently consolidating the unconsolidated substrate and curing the binding agent and first resin thereby bonding the web to the substrate. The bonding can occur without addition of a separate adhesive between the web—binding agent and the substrate.

A method of the invention can further comprise adding a functional barrier to the web. A method of the invention can further comprise forming an unconsolidated substrate. A method of the invention can further comprise adding a catalyst to the binding agent.

In another aspect, described herein is an overlaid composite product made by a method of the invention. An overlaid composite product comprises a functional barrier, a web, a binding agent, and a composite substrate. The composite substrate can be a wood composite panel product. The functional barrier is adhered to the web. The functional barrier—web can be saturated with the binding agent and bonded with the composite substrate. The functional barrier is the outermost layer. The composite substrate can have the functional barrier—web—binding agent bonded to more than one surface of the composite substrate.

An overlaid composite product can be produced by a method comprising treating a web comprising a functional barrier on one face of the web with a binding agent; placing the treated web directly adjacent an unconsolidated substrate wherein the unconsolidated substrate comprises an uncured first resin; and concurrently consolidating the unconsolidated substrate and curing the binding agent and first resin thereby bonding the web to the substrate.

Additional advantages will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 shows one example embodiment of treating a web comprising a functional barrier and placing unconsolidated OSB substrate upon the treated web (i.e., forming and orienting resinated wood strands on the treated web).

FIG. 2 shows example embodiments of the addition of a functional barrier onto a web before placing the barrier—web adjacent an unconsolidated substrate. FIG. 2A illustrates extruding a functional barrier onto a web. FIG. 2B illustrates coating a functional barrier onto a web. FIG. 2C illustrates applying a functional barrier film to a web.

FIG. 3 shows a cross-section of an example embodiment of an overlaid product with a resinated web 200 comprising a functional barrier 100 laminated on a composite substrate 300.

### DETAILED DESCRIPTION

Before the present compositions, articles, devices, and/or methods are disclosed and described, it is to be understood that the aspects described below are not limited to specific embodiments. It is also to be understood that the terminology used herein is for the purpose of describing particular aspects only and is not intended to be limiting.

In this specification and in the claims which follow, reference will be made to a number of terms which shall be defined to have the following meanings:

It must be noted that, as used in the specification and the appended claims, the singular forms “a,” “an,” and “the” include plural referents unless the context clearly dictates otherwise. Thus, for example, reference to “an additive” includes mixtures of additives; reference to “a resin” includes mixtures of two or more such resins, and the like.

“Optional” or “optionally” means that the subsequently described event or circumstance may or may not occur, and that the description includes instances where the event or circumstance occurs and instances where it does not.

Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

References in the specification and concluding claims to parts by weight, of a particular element or component in a composition or article, denote the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

The present invention includes a method for incorporating a web (e.g., paper) treating (e.g., resin saturating) process with the primary process of forming and consolidating unconsolidated composite substrates. A method of saturating a web inline during a primary (e.g., OSB) process would fulfill unmet needs in the industry for a number of reasons, including the following.

Shelf life of commercially available resin saturated and glue lined paper is limited. For example, a saturated phenolic paper may have a shelf life of about 12 to about 16 months under conditions of controlled temperature and relative humidity. However, when it is stored, for example, under typical wood product warehouse conditions where high heat and high relative humidity conditions are prevalent, the shelf life may be shortened dramatically. Under these typical Southeastern U.S. conditions, shelf life may be shortened by 6 months or more. A system of saturating the paper at the same time that strands are formed and consolidated in the OSB process would be desirable since this increases flexibility in sourcing and shipping paper rolls. In addition, unsaturated web, such as kraft paper, does not have a shelf life and can be stored indefinitely.

Saturating web (e.g., paper) in line with a composite substrate (e.g., OSB) forming/consolidating process can eliminate steps in the process and the processing and material costs associated with those steps. For example, instead of shipping unsaturated paper to a resin treater's facility and then to an OSB plant, unsaturated paper could be shipped directly to an OSB plant. Also, saturating in line eliminates a number of steps in the typical process of preparing the overlay. For example, the paper does not have to be unwound and then rewound at the treater's facility during the resin impregnating process. In the traditional process, kraft paper is saturated by immersing the paper in resin (or otherwise resinating the paper) and then partially curing the resin by running the saturated paper through an oven. By saturating in line, such as in the present method, staging is eliminated since the resinated paper is cured and consolidated at the same time as the wood strands. Also, since saturating in line has herein been found to have suitable adhesive bonding between the paper and OSB substrate, the traditional method of adding a glue line and then staging the glue line can be eliminated as well. Finally, the cooling step is no longer needed to bring paper temperatures down to a level for rewinding the resinated paper onto rolls for shipment to an OSB plant.

Saturating in line saves energy also, since the ovens required to stage the resin in the paper requires an enormous amount of energy consumption.

Saturating in line allows for online, quick (and potentially less costly) formulation flexibility to be able to change, for example, the product type, color, water properties (e.g., addition of water repellents), and/or additional functional properties (addition of biocides, fire retardants, traction enhancers, UV resistance additives, etc.).

Also, given the change in steps in the present method, less material (e.g., resin) may be needed to achieve the same result as a conventional process. For example, there is no resin needed for a glue line, unstaged saturating resin may be more efficient at bonding the web to the substrate, thus, requiring less of it, and possibly the resin would have increased functionality since more bonding sites would be available on the unstaged resin for binding with the substrate.

Some potential downsides to any previous in line process is the chance for “wet” resin to transfer to equipment (e.g., material handling equipment and conveyors) and affect release of the product from equipment (e.g., surfaces of press platens, belts, caul plates or screens during substrate consolidation) as well as the potential for contamination of the product and/or the equipment. The current process reduces or eliminates these issues with addition of a functional barrier on the web.

The invention includes a method for saturating web with a functional barrier in line then immediately laminating the saturated web onto unconsolidated composite substrate in the manufacturing process of forming and consolidating the composite substrate so that the conventional two separate steps are combined into a single process. A typical previous method for overlaying resinated paper on OSB substrate included the primary steps of:
1. Unsaturated paper is shipped from a paper mill to saturation treating facility;
2. Paper is set on an unwind machine and fed into a paper saturating machine;
3. Paper is systematically fed into an immersion bath of a resin solution (or other standard resinating process);
4. Paper passes through an oven to evaporate the solvents in the resin (a.k.a. staging the resin);
5. A resin glue line is applied to one side of the staged, resinated paper using, e.g., roll coater, Meyer rod, etc.;
6. Resinated paper with glue line is passed through a second oven to stage the glue line;
7. Resinated paper with glue line is passed through a cooling chamber;
8. Final paper overlay is rewound into large rolls for shipment to an OSB plant;
9. Rolls of overlay shipped from the saturating facility to the OSB mill;
10. Rolls are unwound and fed onto the forming line at the OSB plant where the strands are oriented on top of the overlay or where the overlay is applied to the top of an oriented strand mat; and
11. The oriented strands and overlay are consolidated under heat and pressure to form a panel with a laminated/overlaid face.

A method of the current invention applied in an OSB context can have the following reduced number of steps:
1. Unsaturated paper is shipped from a paper mill to an OSB mill with or without an added functional barrier applied to the unsaturated paper;
2. Functional barrier is applied to the unsaturated paper, if one not previously added to paper;
3. Rolls of unsaturated paper are set on an unwinding machine and paper is systematically fed through an immersion bath of resin (or resin is applied via roll coater, metering roll, gravure roller, Meyer rod roller, curtain coater, pneumatic coaters, spray, foam, electrostatic, or other means);
4. Optionally, wiping rolls can be used to pull off excess resin and ensure uniform coverage and/or nip pressure rolls can optionally be used to drive resin into the paper;
5. Optionally, an accelerant/catalyst/curing agent can be applied to the resin of the resinated paper with the functional barrier;
6. The overlay is fed onto the OSB forming line where wood strands are oriented on top of the overlay or the overlay is fed on top of the wood strand mat; and
7. The mat and overlay are consolidated under heat and pressure to form a panel with laminated/overlaid face.

In addition to the steps described above, the in line saturating method can optionally incorporate a sky roll, e.g., to allow even saturation of the resin into the paper. An accelerant (a.k.a. catalyst or curing agent) can be added directly before or after the resin application to increase the ability of the saturating resin to transfer onto the composite (e.g., furnish) mat surface and catalyze the resin for more efficient cure.

In addition to OSB, other engineered wood products, composite panel products, or other composite substrate products which require consolidation can be overlaid in the current process, such as plywood, oriented strand lumber (OSL), composite strand lumber (CSL), medium density fiberboard (MDF), high density fiberboard (HDF) or hardboard, insulating board, particle board, block board, glu-lam, paper board, com-ply, wood/polymer composite, or any combination thereof. The saturating resin can be, for example, any saturating resin, engineered wood product adhesive resin, or combination thereof (e.g., a polymeric methylene diisocyanate (pMDI), emulsified pMDI, liquid phenol formaldehyde, resorcinol formaldehyde, melamine urea formaldehyde, melamine, or any combination thereof). To achieve a desired color in the product, a pigment can be added to the resin (especially to clear resins such as melamine). Also, additives can be added to the resin or saturating paper to increase product functionality, such as fire retardants or biocides. In addition to kraft paper, fiberglass, polymer (e.g., polyethylene, polyamide, polystyrene), mineral wool (e.g., rock wool), natural fiber (e.g., cotton, jute), or mixtures thereof, for example, can be used as the web.

### A. Compositions/Articles

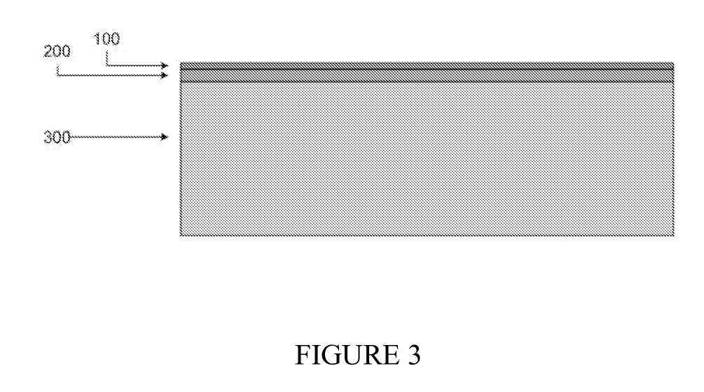

Described herein is an overlaid composite product made as described below in the Methods section. In an example embodiment, this product can be a paper overlaid OSB panel. An article of the invention comprises a substrate 300 overlaid with a web 200. The web 200 comprises a binding agent and a functional barrier 100. See, e.g., FIG. 3.

An article of the invention comprises a substrate 300. A substrate material useful in the current process can be, for example, oriented strand board (OSB). Other engineered wood products or panel products can be used as a substrate. Other substrates can be other composite materials, for example, plywood, oriented strand lumber (OSL), composite strand lumber (CSL), medium density fiberboard (MDF), high density fiberboard (HDF) or hardboard, insulating board, particle board, block board, glu-lam, paper board, com-ply, wood/polymer composite, or any combination thereof. One of skill in the art can determine an appropriate substrate desirable for a particular end use of the overlaid product.

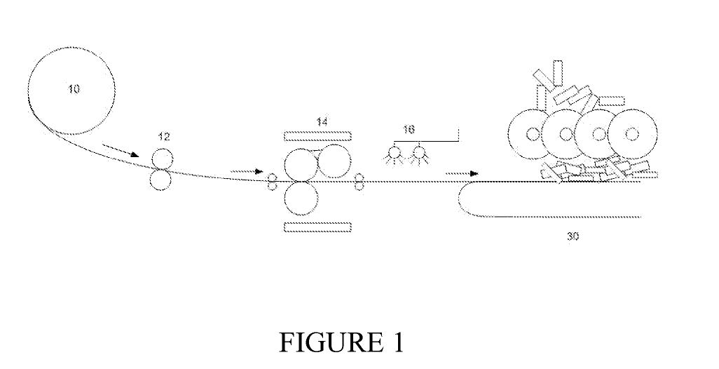

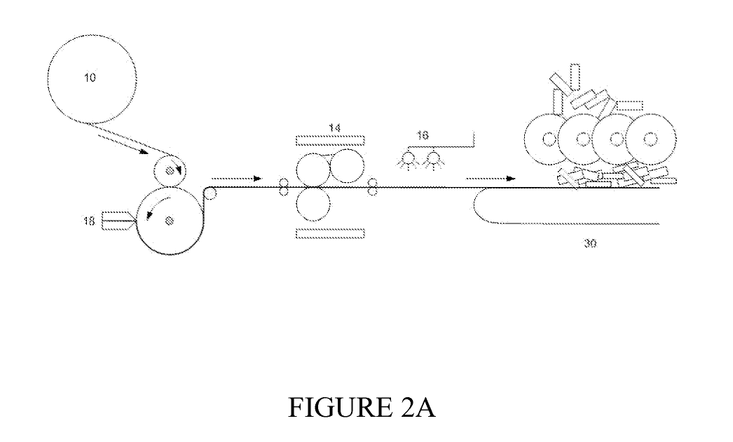

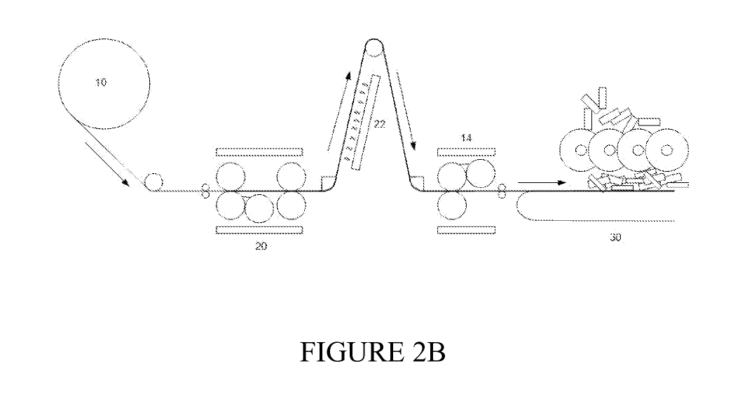

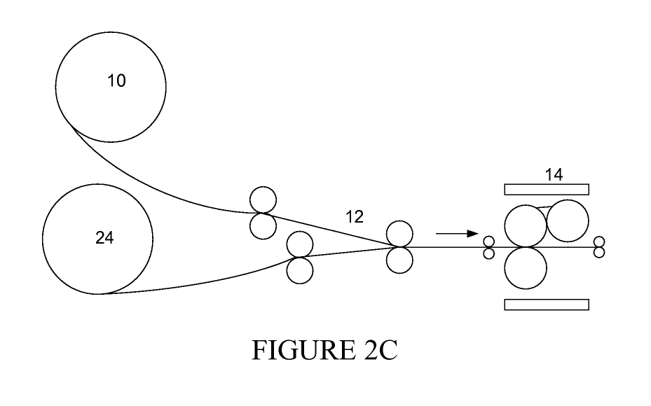

A substrate is initially formed in unconsolidated form in a process of the invention. See, e.g., FIGS. 1 and 2. An overlay can be applied while the substrate is unconsolidated and cured when the substrate is consolidated. For example, unconsolidated OSB is a mat of oriented wood strands (as known in the art, this mat also comprises an adhesive resin and, optionally, other ingredients such as waxes; the art is replete with examples of OSB formulations and forming methods). One of ordinary skill in the art can determine the unconsolidated form of the substrate.

An article of the invention comprises a web 200. A web can be, for example, a paper, such as saturating kraft paper. Other webs can comprise, for example, fiberglass, polymer (e.g., polyethylene, polyamide, polystyrene), mineral wool (e.g., rock wool), natural fiber (e.g., cotton, jute), or mixtures thereof. The web can be woven or non-woven. The web can comprise, for example, paper with a coating, barrier, or film on one side (allowing binding agent to be applied to the opposite side of the web). One of skill in the art can determine an appropriate web taking into account, for example, the substrate and the end use of the final product. Various webs are commercially available or made by processes known to one of ordinary skill in the art.

The web 200 comprises a functional barrier 100. The functional barrier functions to prevent the binding agent from contaminating process equipment and to effect release from, e.g., the press. A functional barrier 100 is added to be web 200; this addition can occur at various stages in the process. A functional barrier 100 can be a thermoset, thermoplastic, or combination material and can be a film, coating, or extrudable plastic, for example. A functional barrier 100 has a glass transition temperature (T_{g}) of equal to or less than room temperature, preferably below outside use temperature, e.g., −10° C.; a melting temperature (Tₘ) of greater than the processing temperature of, e.g., the press, which for OSB is greater than about 400° F.; a Vicat softening temperature (VST) less than the Tₘ and greater than the T_{g} and, preferably at least about 20° C. less than the press temperature; and a liquid resistance once applied to the substrate that will hold out liquid under pressures seen in the manufacturing process up until the press. Also, for applications in which the final product needs to be moisture breathable, a permeance once applied to the substrate of at least about 10 perm, preferably greater than 20 perm, is required. Preferably, the functional barrier is abrasion resistant (sufficient to withstand normal processing and use conditions); will not separate from the web once added; improves the wet strength of the web during processing; prevents transfer of the binding agent or itself to the process equipment; will release from a press after consolidation/cure; and will maintain integrity during press mechanical and thermal forces. The functional barrier also preferably is compatible with end use functionality of the product (e.g., water resistance or permeance). The functional barrier can comprise, for example, engineering plastics, thermoplastic elastomers, liquid applied coatings, and combinations thereof. The functional barrier can comprise additives, for example, color, UV resistance additives, anti-skid additives, and the like. One of ordinary skill in the art can determine an appropriate functional barrier and amount of functional barrier applied to the web.

The web 200 can be purchased from a supplier with the functional barrier 100 already on the web 200. Alternatively, the functional barrier 100 can be added to the web 200 during a process of the invention. Example methods of barrier addition are described in more detail below.

The functional barrier 100 is the outermost portion of the final product, for example, a top portion of an overlaid product as in FIG. 3.

The web 200 comprises a binding agent. A binding agent binds the web 200 to the substrate 300 (provides cohesion and adhesion) so that the overlay will not delaminate from the substrate during end use. The binding agent is compatible with end use functionality of the overlaid product (e.g., water resistance or permeance). A binding agent can be a resin. A resin for use with a paper web can be a typical saturating resin or other binding agent. A “saturating resin” is one known in the web processing industry. The resin can be the same as one used in a wood composite substrate, e.g., those used in OSB manufacture (“OSB resin”). A saturating resin can be, for example, an isocyanate, urethane, or a proteinaceous resin (particularly, e.g., polymeric methylene diisocyanate (pMDI), emulsified pMDI, phenol formaldehyde, resorcinol formaldehyde, melamine urea formaldehyde, melamine urea phenol formaldehyde, and/or melamine), or mixtures thereof. A resin can be a thermosetting or thermoplastic resin. One of skill in the art can determine an appropriate binding agent taking into account, for example, the web, the substrate, and the final end use of the product.

The web is treated with a binding agent; methods of treating are described in more detail below. A binding agent saturates the web. The binding agent should saturate throughout the thickness of the web. Preferably, the binding agent is essentially homogeneously distributed through the thickness of the web, but it need not be homogeneously distributed to be functional. The amount of binding agent to be applied to the web can be determined by one of ordinary skill in the art. Binding agents are commercially available or can be formulated by one of ordinary skill in the art.

Additional compounds, compositions, and/or functional additives can be optionally added to an article of the invention. Various functional additives are known in the art. In one example embodiment, to achieve a desired color in the product, a pigment can be added to a resin (especially to clear resins such as pMDI or melamine). Additives can be added to the resin or web to increase product functionality, such as fire retardants, biocides, water repellants, traction enhancers, and/or UV resistance additives. One of ordinary skill in the art can determine appropriate additional additives and the amounts thereof.

### B. Methods

A method of the current invention can comprise treating a web comprising a functional barrier on one face of the web with a binding agent, placing the treated web directly adjacent an unconsolidated substrate, concurrently consolidating the unconsolidated substrate and curing the binding agent. See, e.g., FIG. 1. The method can further comprise adding a functional barrier to the web. See, e.g., FIG. 2. The method can further comprise forming an unconsolidated substrate. See, e.g., FIGS. 1 and 2. The method can further comprise adding a catalyst to the binding agent. See, e.g., FIGS. 1 and 2A.

Treating the web with a binding agent can comprise resinating the web. The web and binding agent are described in more detail above. The treatment can comprise, for example, saturating, coating, or extruding the binding agent onto and into the web. The web is treated with the binding agent on the web face opposite the functional barrier on the web. In an example embodiment, the binding agent can be applied using a direct roll coater 14. See, e.g., FIGS. 1 and 2. In an example embodiment, the web can be unwound 10 and fed through tracking/take up rolls 12 to a treating area 14 (e.g., FIG. 1). FIG. 1 illustrates an example embodiment where the web was supplied to the process with the functional barrier already applied to the web.

In an example embodiment, rolls of unsaturated paper can be set on an unwinding machine 10 and the paper systematically fed through a direct roll coater of resin. Other methods of applying binding agent to the web include using, for example, an immersion bath, a metering roll, a gravure roller, a Meyer rod roller, a curtain coater, a pneumatic coater, spray coating, foam application, electrostatic application, or other means or combination thereof. One of skill in the art can determine an appropriate way of applying binding agent to the web.

Wiping rolls, for example, can optionally be used to pull off excess binding agent and assure uniform coverage of the web with the binding agent. Nip rolls, for example, can optionally be used to force the binding agent into the web.

The formulation of and amount of binding agent can be determined by one of ordinary skill in the art based on the web composition, substrate composition, and end use and requirements of the overlaid product.

Placement of the treated web directly adjacent an unconsolidated substrate can comprise placing the treated web on top of the unconsolidated substrate or forming the unconsolidated substrate 30 on top of the treated web (see, e.g., FIGS. 1 and 2). Alternatively, the treated web can be placed on the top and bottom of the unconsolidated substrate.

When the treated web comprising a functional barrier is placed directly adjacent the unconsolidated substrate, the binding agent is uncured. “Uncured” means less than partially cured—pre B-stage; substantially/essentially uncured only includes curing that can occur at ambient conditions and during length of time for manufacturing.

Concurrently consolidating the unconsolidated substrate and curing the binding agent can, for example, comprise placing the unconsolidated substrate with the directly adjacent treated web comprising a functional barrier in a press and applying effective heat and effective pressure for an effective period of time. One of ordinary skill in the art can determine the appropriate type of press, temperature, pressure, and time to both consolidate (and cure, if appropriate for the composite) the substrate and cure the binding agent. Another example of consolidation and cure can comprise irradiation with microwaves. One of ordinary skill in the art can determine appropriate methods and conditions for consolidating and for curing.

Adding a functional barrier to the web can occur at any time between formation of the web and up to application of the web-functional barrier to the substrate comprising the functional barrier with the binding agent.

Untreated web, e.g., unsaturated paper, can be shipped from a web manufacturer (e.g., paper mill) to a composite product (e.g., overlaid panel) manufacturer (e.g., an OSB mill). Untreated web with a functional barrier applied on one face of the web can be shipped from a web manufacturer or intermediate processor to a manufacturer producing overlaid products of the current invention.

One of ordinary skill in the art can determine various methods for adding a functional barrier to the web. In one example embodiment, the functional barrier is extruded onto the web (see, e.g., FIG. 2A). As the web unwinds 10, the functional barrier is extruded through a die 18 onto the web. In one example embodiment, the functional barrier is coated onto the web (see, e.g., FIG. 2B). As the web unwinds 10, a reverse fill machine or direct roll coater 20 coats the functional barrier onto the web. After coating, the functional barrier can be cured 22, for example, by infrared (IR) or ultraviolet (UV) or other methods known to the art. In one example embodiment, the functional barrier is applied to the web as a film (see, e.g., FIG. 2C). As the web unwinds 10, a functional barrier unwinder 24 unwinds the functional barrier film and the film is applied to the web.

Forming an unconsolidated substrate is performed using conventional formulations and methods known to one of ordinary skill in the art. For example, OSB formulations and mat forming methods are well known in the art. In an example embodiment, wood strands mixed with other OSB ingredients are oriented on top of the treated web comprising a functional barrier 30. See, e.g., FIGS. 1 and 2. Appropriate choices of unconsolidated substrate formation, based on end use of the overlaid product, can be made by one of ordinary skill in the art.

Adding a catalyst to the binding agent can comprise any conventional addition method known in the art. For example, certain binding agents can be catalyzed by water addition. In an example embodiment, water can be sprayed or misted over the binding agent 16. See, e.g., FIGS. 1 and 2A. The type of catalyst, amount, and method of addition can be determined by one of ordinary skill in the art.

In addition to the steps described above, the in line method can optionally incorporate, for example, a sky roll to allow even saturation.

### C. Utility/Applications

In an example embodiment, an overlaid product made by a method of the invention wherein the substrate is OSB can be used as a structural sheathing panel with a water resistant barrier surface. An example application of the product can be for a breathable, water resistant barrier for wall sheathing and/or a water resistant roof sheathing/underlayment product for roofs.

### EXAMPLES

The following examples are put forth so as to provide those of ordinary skill in the art with a complete disclosure and description of how the compositions, articles, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of conditions, e.g., component concentrations, temperatures, pressures and other ranges and conditions that can be used to optimize the product obtained from the described process. Only reasonable and routine experimentation will be required to optimize such process conditions.

### Example 1

### Proof of Concept

Small oriented strand board (OSB) boards measuring ½″ by 20″ by 20″ were generated in a laboratory to simulate larger OSB panels produced in a mill process.

A conventional OSB formulation comprising dried Southern yellow pine wood strands, polymeric diphenylmethylene diisocyanate (pMDI) resin, and powder phenol formaldehyde (PF) resin was acquired from an OSB facility. Conventional resin loadings and mixing were used in the formulation. The pMDI resin used was Mondur® 541 (Bayer Material Science, Pittsburgh, Pa.), and the PF resin used was Cascophen W3154 (Hexion Chemical, Columbus, Ohio).

Sheets of saturating kraft paper were cut to measure the same surface dimensions as the planned mat. Three types of saturating kraft paper (MeadWestvaco, Charleston, S.C.) were used in the experiments—a 90 lb/3000 ft² basis weight (146 g/m²) paper, a 90 lb/3000 ft² basis weight (146 g/m²) experimental paper, and a 99 lb/3000 ft² basis weight (161 g/m²) paper.

Next, pMDI resin (Mondur® 541 (Bayer Material Science, Pittsburgh, Pa.)) was applied with a roll coater to the surface of one side of the paper in an amount of approximately 3 to approximately 20 grams/sq ft. The paper appeared to wet out well (i.e., visually appeared to be uniformly wet across the paper) when the resin was applied. A light mist (a garden spray bottle was used to mist over the whole surface of the resinated paper one time) of tap water was sprayed across the surface of the resin-saturated paper to better facilitate the later transfer and cure of the pMDI resin from the kraft paper to the wood strands during pressing.

A sheet of release paper (“off the shelf” release paper used in laminating) was then placed down with the saturated paper placed on top. The surface of the saturated paper to which the resin and water were applied was placed with that surface facing upward so that it would contact the OSB wood furnish.

The blended strands were then randomly formed in a small box (½″ by 20″ by 20″) on top of the saturated paper. Another piece of release paper was placed on top of the formed mat. The formed mat with paper was then pressed to a desired thickness under heat and pressure. A Siempelkamp Lab Press was used for a 3 minute and 45 sec. press time including a time of approximately 30 sec. to reach thickness and a 45 sec. degas. The maximum pressure was set at 800 psi, and the press platen temperature was 400° F.

This method was also performed by placing the resinated paper on top of the furnish rather than the bottom.

Observations from pressing indicated the pMDI resin (having a propensity to flow) had saturated the paper completely. Visual observation was that the color, texture, and rigidity of the paper appeared even across the sample.

Two primary tests were conducted on the prototypes to measure bond quality and water resistance.

First, bond quality of the prototypes was measured using a modified internal bond test (modified ISO test). This test required a 2-inch aluminum block to be adhered with hot melt to the overlay surface. The overlay surface was then scored with a knife around the perimeter of the metal block. The test block was then pulled off in the direction perpendicular to the specimen surface at a rate of 0.05 inches per minute using a Q-Test/50LP Universal Test Machine manufactured by MTS. The cross section of the block and specimen surface was then observed for bond quality (Table 1) and a percentage of wood failure was determined for each specimen. The higher the rating of wood failure, the better the bond. A 100% wood failure indicates a perfect bond of the overlay. An individual wood failure rating of less than 60%, for example, would indicate poor adhesion to the substrate or cohesiveness of the paper and would indicate poor overall bond quality.

The in line process conditions were found to produce a laminated board that had a bond quality that was not significantly different than a control. The control was a board produced using a commercially available OSB overlaid with paper pre-saturated with resin and with glue line (ZIP sheathing, Huber Engineered Woods LLC, Charlotte, N.C.). The results are shown below in Table 1.

TABLE 1
Bond Quality testing results.

| | | | | Significantly |
|---|---|---|---|---|
| | | | | different than |
| Specimen | Wood failure % | Std. Dev. | p-value | control* |
| 99# paper | 92 | 2.12 | 0.303 | No |
| 90# | 93 | 3.54 | 0.849 | No |
| experimental | | | | |
| paper | | | | |
| 90# paper | 96 | 5.66 | 0.524 | no |
| Control | 95 | 1.41 | | |

*ANOVA analysis p ≦ 0.05

Cobb ring tests were also performed according to ASTM D5795, The Standard Test Method for Determination of Liquid Water Absorption of Coated Hardboard and Other Composite Wood Products via “Cobb Ring” Apparatus, to measure the water resistance of the overlay. A cobb ring unit is equal to 100 grams per square inch (645 cm²) and indicates the amount of distilled water that passes through the overlay and is absorbed by the underlying wood substrate over a 24-hour period. The results (Table 2) show that the prototype samples performed similarly to the control in this test.

TABLE 2
Water Resistance testing results.

| | Cobb Unit | | | Significantly |
|---|---|---|---|---|
| | Values | | | different than |
| Specimen | (g/100 in²) | Std. Dev. | p-value | control* |
| 99# paper | 20.7 | 0.06 | 0.111 | No |
| 90# | 21.7 | 1.70 | 0.203 | No |
| experimental | | | | |
| paper | | | | |
| 90# paper | 18.9 | 1.25 | 0.460 | No |
| Control | 17.75 | 0.74 | | |

*ANOVA analysis p ≦ 0.05

### Example 2

### Proof of Concept 2

In a second experiment, laminated boards were produced in the same fashion as described in Example 1; however, a melamine urea-phenol-formaldehyde (MUPF) saturating resin was used instead of pMDI. The MUPF resin was PMUF 1288 (Hexion Chemical, Demopolis, Ala.).

The MUPF resin was applied using a direct roll coater to one side of the paper on some samples and on both sides of the paper on other samples.

Observations (i.e., visual observations of evenness) from pressed boards showed, in order to completely saturate and “wet out” the paper, resin had to be applied to both sides of the paper or the paper had to first be immersed in resin. That is, while applying pMDI resin to one side of the paper with a water spray was enough to bond and completely saturate the paper under primary process conditions, the MUPF, on the other hand, had to be applied to both sides to achieve the same results. This may be because not only does the MUPF have a higher molecular weight decreasing its ability to saturate but also because the MUPF does not flow well under typical pressures used in OSB manufacturing (though it is known that this can be overcome with vacuum or pressure application techniques or other mechanical means). Therefore, more MUPF resin had to be applied than pMDI resin. Approximately 10 to about 20 grams per square foot of MUPF resin was applied to the paper in order to get the desired effect of visually even saturation.

The MUPF saturated paper laminated boards were formed and pressed in the same fashion as the boards in Example 1. It was visually observed that the MUPF paper saturated boards had a more blotched appearance and exhibited increased telegraphing of the underlying OSB surface. (Telegraphing is where the outline or shadow of wood strands in the OSB is noticeable on the surface of the paper.)

Results of testing these MUPF prototypes showed bonding and water resistance values lower than values for the pMDI saturated paper (Table 3).

TABLE 3
Bond quality test results.

| | pMDI | MUPF | Control |
|---|---|---|---|
| Mean | 97 | 9 | 94 |
| Standard Deviation | 3 | 7 | 2.72 |
| Range | 8 | 16 | 8 |
| Minimum | 92 | 0 | 92 |
| Maximum | 100 | 16 | 100 |
| Count | 8 | 8 | 8 |

A bond durability test was performed only on the pMDI sample according to PS-1-95 Construction and Industrial Plywood, Sections 6.1.5.1 and 6.1.5.3 for Tests for Exterior Plywood and Interior bonded with exterior glue.

TABLE 4
Bond durability test results.

| | pMDI | Control |
|---|---|---|
| Mean | 93 | 92 |
| Standard | 6.71 | 5.67 |
| Deviation | | |
| Range | 20 | 13 |
| Minimum | 80 | 85 |
| Maximum | 100 | 98 |
| p-value | 0.796 | |

Cobb ring tests were performed.

TABLE 5
Cobb ring test results.

| | pMDI | MUPF | Control |
|---|---|---|---|
| Mean | 7.19 | 11.88 | 7.88 |
| Standard Error | 0.49 | 1.09 | 0.44 |
| Median | 6.73 | 12.26 | 7.85 |
| Standard | 0.86 | 3.07 | 0.76 |
| Deviation | | | |
| Sample Variance | 0.73 | 9.45 | 0.58 |
| Range | 1.52 | 10.58 | 1.52 |
| Minimum | 6.65 | 6.33 | 7.13 |
| Maximum | 8.17 | 16.91 | 8.65 |
| Count | 3 | 8 | 3 |

### Example 3

### Proof of Concept 3

In a third experiment, laminated boards were produced in the same fashion as described in Example 1 (other than the thickness was 7/16″); however, a phenol formaldehyde (PF) saturating resin was used instead of pMDI and MUPF. Two PF saturating resins were used in the experiment, GP 594G04, a low molecular weight resin, and GP 548G51, a high molecular weight resin, each obtained from Georgia-Pacific Resins, Inc. (Decatur, Ga.). A 50:50 blend of the low and high molecular weight resins (“mid”) was also used.

The PF resin was applied using a direct roll coater to one side of the paper in the designed experiment (Table 6) and two both sides in additional prototypes (Table 7).

Observations (i.e., visual observations of evenness) from pressed boards showed, in order to completely saturate and “wet out” the paper, resin had to be applied to both sides of the paper or the paper had to first be immersed in resin. That is, while applying pMDI resin to one side of the paper with a water spray was enough to bond and completely saturate the paper under primary process conditions, the PF, on the other hand, had to be applied to both sides to achieve the same results. The PF resin applied to one side only showed poor ability to saturate through the entire depth of the paper. Lower molecular weight PF showed better ability to saturate but not as good as what was observed with the pMDI. Also, the PF resin does not flow well under typical pressures used in OSB manufacturing (though it is known that this can be overcome with vacuum or pressure application techniques or other mechanical means). Therefore, more PF resin had to be applied than pMDI resin. Approximately 10 to about 25 grams per square foot of PF resin was applied to the paper in order to get the desired effect of visually even saturation. Using the above described techniques to force even penetration of the PF resin may allow the application rate of the resin to be reduced.

The PF saturated paper laminated boards were formed and pressed in the same fashion as the boards in Example 1, except for thickness of 7/16 ″. It was visually observed that the PF paper saturated boards had a more blotched appearance where resin had completely saturated to the other side of the paper in some areas and was not fully saturated in others.

Results of testing the PF prototypes showed poor bonding when resin was applied to one side only, and most of the bond failures were due to poor cohesiveness of the paper, indicating poor saturation. However, resin applied to both sides showed adequate bonding. Also, specimens with the PF resin blend containing low and middle level molecular weights showed an increased ability to drive into the paper and saturate more completely; however, these specimens also had a poorer ability to cure in the press. It is believed at the time of this study that a high molecular weight PF resin could be applied to one side only and subsequently forced into the paper by nip/pinch rolls or other mechanical means in order to achieve complete curing and saturation.

TABLE 6
Designed Experiment results of PF resin applied to one side of paper.

| | | Wet | | |
|---|---|---|---|---|
| Run | PF Resin MW | mils | % Wood Failure | Cobb Units |
| 1 | Low | 2.16 | 5 | 69.56 |
| 2 | Low | 0.54 | 2 | 68.44 |
| 3 | Mid | 2.16 | 20 | 27.17 |
| 4 | Mid | 0.54 | 20 | 48.72 |
| 5 | High | 2.16 | 0 | 40.31 |
| 6 | Low | 1.08 | 0 | 59.78 |
| 7 | Mid | 0.81 | 2 | 46.24 |
| 8 | Mid | 1.62 | 1 | 36.62 |
| 9 | High | 1.08 | 0 | 39.27 |
| 10 | High | 0.81 | 0 | 41.27 |
| 11 | Mid | 1.08 | 2 | 30.29 |
| 12 | Low | 1.62 | 3 | 87.03 |
| 13 | High | 0.54 | 45 | 43.27 |
| 14 | High | 1.62 | 25 | 53.61 |
| 15 | Low | 0.81 | 3 | 77.33 |

TABLE 7
Results of saturating pMDI on one side paper, PF (high MW)
on two sides of paper, and PF (high MW)/pMDI on two sides.

| Specimen | Wood Failure % | Cobb Units |
|---|---|---|
| pMDI one side | 100 | 17.31 |
| pMDI two sides | 95 | 14.26 |
| PF bottom/pMDI top | 100 | 13.86 |
| PF two sides | 98 | 24.28 |

### Example 4

### Proof of Concept 4

In a fourth experiment, laminated boards were produced in the same fashion as described in Example 1 (except 7/16″ thickness) with a pMDI resin; however, no water catalyst was sprayed onto the resin saturated paper. In this experiment, a saturating kraft grade of paper (MeadWestvaco, Charleston, S.C.) was again used—a 90 lb./3000 ft², an experimental 90 lb./3000 ft², and a 70 lb./3000 ft² paper. Also, a functional barrier consisting of a thermoplastic elastomer (TPE) with a Tₘ=218° C., Vicat Softening temperature with 10 Newton Force applied=205° C., and Permeability=30 perms @ 1 mil thickness was pre-applied to one side only of the paper as a film through heat and pressure of the same press at 500° F. for 30 sec. and a maximum pressure of 800 psi before saturating.

The pMDI resin was applied using a direct roll coater to one side of the paper. Observations (i.e., visual observations from applying resin) from the paper showed the pMDI completely “wetted out” the surface it was applied to, but the pre-applied barrier was able to block the pMDI resin from flowing completely through the overlay and to the other surface, as was noted in Example 1.

Observations (i.e., visual observations of release from press screens) from pressed boards showed the barrier allowed the boards uninhibited release from the metal press screens. Since pMDI will stick and chemically bond to metal surfaces, an uninhibited release indicated the barriers have the ability to block resins from flowing through the paper during the heat and pressure of the pressing cycle. Furthermore, no residue was observed on the press screens, and this indicated the barrier has the durability to endure the heat and pressure of the pressing cycle and does not soften and/or degrade to a considerable extent.

Results of testing with the TPE/pMDI prototypes showed bonding of <90% wood failure which was lower than controls and past experiments with pMDI (Table 8). This may have been due to lower resin levels used and no catalyst being sprayed to aid in transfer and curing. At the time of this experiment, it was believed the lower bond quality was not due to cohesiveness between the functional barrier and the saturated paper.

TABLE 8
Bond durability (modified Internal Bond (IB) test) test results.

| | % Wood Failure | | | | | |
|---|---|---|---|---|---|---|
| Description | Ind'l | Avg | Std Dev | Min | Max | Range |
| TPE on 70# paper | 85 | | | | | |
| @ 3.8 g/sf pMDI | 88 | | | | | |
| saturation | 82 | | | | | |
| | 83 | | | | | |
| | 81 | | | | | |
| | 83 | 83.7 | 2.5 | 81 | 88 | 7 |
| Control | 92 | | | | | |
| Control | 94 | 93 | 1.4 | 92 | 94 | 2 |

TABLE 9
Bond Quality (modified IB) Test Failure mode results.

| Sample | Failure mode |
|---|---|
| Control | adhesion to substrate and cohesion of |
| | paper |
| TPE on 70# paper | adhesion to substrate |

TABLE 10
Cycled Bond Durability (PS1 standard from Ex. 2) test results.

| | % Wood Failure | | | | | |
|---|---|---|---|---|---|---|
| Description | Individual | Average | Std Dev | Min | Max | Range |
| TPE on 70# paper | 75 | | | | | |
| @ 3.8 g/sf pMDI | 65 | | | | | |
| saturation | 10 | | | | | |
| | 0 | | | | | |
| | 75 | | | | | |
| | 25 | | | | | |
| | 5 | | | | | |
| | 5 | | | | | |
| | 5 | | | | | |
| | 75 | | | | | |
| | 10 | 31.8 | 33.0 | 0 | 75 | 75 |
| Control | 85 | | | | | |
| | 90 | | | | | |
| | 95 | | | | | |
| | 98 | 92.0 | 5.7 | 85 | 98 | 13 |

TABLE 11
Water resistance results from Cobb Ring test.

| | Cobb Unit | | | | | |
|---|---|---|---|---|---|---|
| | Values | | | | | |
| Description | Individual | Average | Std Dev | Min | Max | Range |
| TPE on 70# paper | 11.2 | | | | | |
| @ 3.8 g/sf pMDI | 9.1 | | | | | |
| saturation | 8.4 | | | | | |
| | 11.9 | | | | | |
| | 11.8 | 10.5 | 1.6 | 8.4 | 11.9 | 3.5 |
| OSB w/No | 142.5 | | | | | |
| Barrier | 110.4 | 126.5 | 22.7 | 110.4 | 142.5 | 32.1 |
| Control | 17.5 | | | | | |
| | 17.5 | 17.5 | 0.0 | 17.5 | 17.5 | 0.0 |

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed is:

1. A method for producing an overlaid composite product comprising
a) treating a web comprising a functional barrier on one face of the web with a binding agent;
b) placing the treated web directly adjacent an unconsolidated substrate wherein the unconsolidated substrate comprises an uncured first resin; and
c) concurrently consolidating the unconsolidated substrate and curing the binding agent and first resin thereby bonding the web to the substrate without addition of a separate adhesive.

2. The method of claim 1 further comprising adding a functional barrier to the web.

3. The method of claim 1 further comprising forming an unconsolidated substrate.

4. The method of claim 1 further comprising adding a catalyst to the binding agent.

5. The method of claim 1 wherein the functional barrier is thermoset or thermoplastic material.

6. The method of claim 5 wherein the thermoset or thermoplastic material comprises a film, coating, or extrudable plastic.

7. The method of claim 1 wherein the web is paper, fiberglass, polymer, mineral wool, natural fiber, or mixtures thereof.

8. The method of claim 1 wherein the web is woven or non-woven.

9. The method of claim 1 wherein the binding agent is a saturating resin comprising isocyanate, urethane, and/or proteinaceous resin.

10. The method of claim 9 wherein the saturating resin comprises polymeric methylene diisocyanate (pMDI), emulsified pMDI, phenol formaldehyde, melamine urea formaldehyde, melamine urea phenol formaldehyde, resorcinol formaldehyde, melamine, or mixtures thereof.

11. The method of claim 1 wherein the binding agent is the same as the first resin.

12. The method of claim 1 wherein the binding agent is different from the first resin.

13. The method of claim 1 wherein the substrate is oriented strand board (OSB), plywood, oriented strand lumber (OSL), composite strand lumber (CSL), medium density fiberboard (MDF), high density fiberboard (HDF) or hardboard, insulating board, particle board, block board, glu-lam, paper board, com-ply, wood/polymer composite, or any combination thereof.

14. The method of claim 1 wherein the web is paper and wherein the substrate is oriented strand board.

15. The method of claim 1 wherein step c) comprises pressing for an effective period of time under effective conditions of temperature and pressure.

16. The method of claim 1 wherein step c) comprises pressing for an effective period of time under effective conditions of radiation and pressure.

17. The method of claim 2 wherein adding the functional barrier to the web comprises extruding, coating, or applying a film of the functional barrier onto one face of the web.

18. The method of claim 3 wherein forming an unconsolidated substrate comprises mixing an uncured first resin with wood strands or wood particles and forming a mat by orienting the wood strands or wood particles.

19. The method of claim 4 wherein adding a catalyst to the binding agent comprises spraying water over the treated web.

20. The method of claim 1 further comprising adding water repellants, biocides, fire retardants, traction enhancers, and/or UV resistance additives to the functional barrier, binding agent, and/or web.

21. A method for producing an overlaid oriented strand board (OSB) panel comprising
a) treating a kraft paper web comprising a functional barrier on one face of the web with a binding agent comprising a saturating resin;
b) forming an unconsolidated OSB substrate comprising an uncured OSB resin;
c) placing the treated web directly adjacent an unconsolidated OSB substrate; and
d) concurrently consolidating the unconsolidated OSB substrate and curing the saturating resin and OSB resin thereby bonding the web to the OSB substrate by pressing under effective temperature and pressure for an effective period of time.

22. An overlaid wood composite panel produced by a method of claim 1.

23. An overlaid composite product produced by a method comprising
a) treating a web comprising a functional barrier on one face of the web with a binding agent;
b) placing the treated web directly adjacent an unconsolidated substrate wherein the unconsolidated substrate comprises an uncured first resin; and
c) concurrently consolidating the unconsolidated substrate and curing the binding agent and first resin thereby bonding the web to the substrate without addition of a separate adhesive.
